(19) United States
(12) Patent Application Publication
(10) Pub. No.: US 2004/0112033 A1
(43) Pub. Date: Jun. 17, 2004

(54) Safety and harvesting device for fruit

(76) Inventor: Tim Straatmans, Boyne Island (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/471,212

(22) PCT Filed: Mar. 13, 2002
(86) PCT No.: PCT/AU02/00282

(30) Foreign Application Priority Data
Mar. 13, 2001 (AU) PR 3706
Mar. 6, 2002 (AU) PS 0914

(51) Int. Cl. A01D 46/22

(52) U.S. Cl. 56/329

(57) ABSTRACT

A device (11) for catching fruit from a fruit-bearing tree. The device (11) has a catching means (10) formed from at least one wall so as to define a catching zone (9). A collecting zone (17) is located within or near a lowermost region of the catching zone (9) so that fruit falling into catching zone (9) is guided by the wall towards the collecting zone (17).

### FIELD OF THE INVENTION

The present invention relates to a safety and harvesting device. More particularly the invention relates to a safety and/or harvesting device for use with fruit bearing trees.

The present invention will be described with reference to coconut palms. However, it will be appreciated that the device of the present invention may be used with any suitable tree and no limitation is intended thereby.

In the present specification and claims, the term fruit will be understood to refer to any fruiting body or part thereof of a tree and includes seeds, seedpods and nuts.

### BACKGROUND OF THE INVENTION

Falling fruit from trees such as coconut, breadfruit and jackfruit trees can pose a danger to people in the vicinity of the tree. People have been injured and in some cases killed by falling coconuts. Property such as cars may also be damaged by falling fruit. Measures which have been employed to minimize the risks associated with such trees includes simple warning signs alerting people to the dangers, removing fruit when green before it ripens and falls and even removing the offending trees. Fruit removal is a manually intensive and costly procedure. Further, green fruit may still become dislodged under conditions such as high wind or be loosened or dislodged by animals feeding on the fruit. Whilst tree removal is a final solution in many cases it is neither environmentally, culturally, nor aesthetically desirable.

Other types of trees drop fruit, nuts, seeds and the like, which although may not pose a safety threat, the falling of such bodies may be undesirable. For example, the dropping of fruit, seeds or the like onto areas such as lawns, golf greens, swimming pools and the like is undesirable for many reasons. Currently, when trees are fruiting and dropping fruit, the dropped fruit must be manually cleared from the area. Such clearing is typically manually intensive and can add to maintenance costs.

Harvesting of fruit from trees may also be an energy intensive process. Harvesting of coconuts for example is still carried out by traditional methods. The simplest method is to wait for the coconuts to fall on the ground and manually pick them up. A disadvantage of collecting coconuts from the ground is that it is manually intensive. Further, whilst on the ground coconuts are susceptible to damage by animals and rodents in particular. Alternatively and/or in addition to, trained climbers climb the trees to pick the coconuts. In some Asian countries specially trained monkeys are used for this purpose. Seed collection is another area where collectors wait for seeds to fall onto the ground and/or climb trees to collect the seeds. Again this is a manually intensive process. Further, climbing trees is an inherently risky procedure.

Various types of fruit collecting or harvesting devices have been proposed over the years. Some of these devices include a fruit catching apron or the like which extends radially from the trunk of the tree. In many cases, these earlier devices include quite complicated attachment and support means in the form of rigid support arms. Some earlier devices represent inverted umbrellas. Some of these devices include complicated means for guiding the fruit from a catching are to a collection area. These earlier devices generally include numerous parts, are expensive to manufacture and complicated and time consuming to install. Further, in view of the complicated nature of the devices and moving parts therein, regular maintenance is required. Further such devices are subject to damage by the weight of the falling fruit themselves and under adverse weather conditions. Further, it is believed that many of these earlier devices were developed based on the assumption that trees grow vertically and trunks have a circular cross-section. In practice this is not always the case and the present inventor is unaware of any such devices being in commercial use today.

It is therefore an object of the present invention to provide a device for collecting vegetation falling from a tree, which may at least partially overcome the above disadvantages or provide the public with a useful or commercial choice.

### SUMMARY OF THE INVENTION

According to a first broad form of the invention there is provided a device for use with a fruit-bearing tree, the device including;

a catching means mountable about a trunk of the tree beneath a fruit bearing region of the tree, and when mounted about the trunk,

the catching means has at least one side wall;

the wall defines a catching zone; and

a collection zone is located within or near a lowermost region of the catching zone such that fruit falling into the catching zone is guided by the wall towards the collecting zone.

The catching means may be of any suitable size, shape and construction. It will be appreciated by persons skilled in the art that these parameters may be varied depending upon the type of tree, the type of fruit and the like. The catching means has at least one wall. Typically, the catching means when mounted about the trunk of a tree, encircles the tree.

The catching means is mountable about the trunk of a tree. Typically the catching means when mounted has a substantially circular aperture through which the tree trunk passes. Preferably, the perimeter of the aperture contacts and/or locates snugly about the tree trunk. An advantage of this arrangement is that the catching means can provide a barrier to animals climbing the trunk to eat the fruit.

The aperture may have a flexible perimeter. For example, the aperture may be lined with substantially flexible tree contacting projections, which in use contact the tree. The flexibility of the projections allows the aperture to accommodate trunks of different diameters and trunks, which do not have a circular cross-section. Alternatively, the aperture may be lined with a layer of a resilient material such as a foam.

The catching means may be formed from a single piece of material, having a slot, or gap which allows the catching means to be placed about the trunk. Opposing side edges of the slot or gap may then be joined. Alternatively, the catching means may be formed from two or more panels, which may be joined around the tree. Preferably, the catching means can be stored in a flat storage position.

The device may also include anchor means configured to be positioned at a desired height on the trunk of a tree. The anchor means may be in the form of a collar, which is capable of encircling the trunk at the desired height. The collar may be in the form of a chain, belt or strap and may be adjustable to suit a diameter of the trunk. The device may further include one or more support members extending between the anchor means and the catching means. Typically, the anchor means is located above the catching means and the at least one support member extends downwardly from the anchor means. The support members may be rigid or flexible, with substantially flexible members being preferred. A degree of flexibility allows the device to be buffeted by a wind. Preferably, the support members are of adjustable length. This allows the position of the catching zone relative to a tree trunk to be varied such that the device may be mounted to a tree trunk which is at an angle to the vertical whilst still being at an optimum position to catch falling fruit. It is known that trees such as coconut palms do not always grow in a strictly vertical manner.

According to a further broad form of the invention there is defined a device for use with a fruit bearing tree, the device including a catching means mountable about the tree trunk beneath a fruit bearing region of the tree, a support structure having an anchor means configured to be positioned at a desired height on the trunk of the tree above the catching means and support members extending between the catching means and the anchor means.

The anchor means is typically in the form of a length of chain, tie or webbing strap that is adjustable to fit a range of tree trunks having different diameters. The support members or ties may be in the form of radially extending strips of nylon webbing. The respective lengths of webbing may include buckles or other means for adjusting the length thereof.

When the device is mounted to a tree, the at least one wall of the catching means defines a catching zone beneath a fruit bearing region of the tree. Typically, when viewed in plan, the catching zone has an outer upper perimeter that is substantially circular and extends radially from the trunk. Alternatively, the catching zone when viewed in plan may be hexagonal or any other suitable shape.

The device has a collecting zone located within the catching zone and when the device is mounted to a tree, the collecting zone is located at or near the lowermost part of the catching zone and the wall is configured such that fruit fall into the catching zone is guided towards the collecting zone.

In a particularly preferred form of the invention, the catching zone has a shape corresponding to an inverted scalene cone or pyramid, and a scalene cone is particularly preferred. In this case, the upper perimeter of the catching means is formed by the open base of the cone or pyramid and the collection zone is located at or near the apex of the cone or pyramid. When the catching means is cone shaped, there will be essentially a single side wall. Where the catching zone is in the shape of a pyramid, the catching means will have at least three side walls. The tree trunk typically passes through the centre of the base at an angle to the axis of the cone or pyramid.

The device may also include a collecting means beneath the collecting zone to collect fallen fruit. The collecting means may be in any suitable configuration, which may of course vary with the size, shape, and number of fruit, seeds or the like to be collected. The collecting means may be in the form of a basket or sock. The collecting means may have a closure moveable between a collecting position and a fruit releasing position. Alternatively, or in addition to, the collecting means may be removably attachable to the catching means. In this way, the collecting means may be disconnected from the catching means and emptied before replacing the collecting means. In a particularly preferred form of the invention, the collecting means can be operated by an operator located on the ground such that the collecting means can be lowered to enable easy collection. Alternatively, the whole device may be lowered to the ground to allow fruit to be collected. Suitable devices to enable raising and lowering of the catching means and/or collecting means includes pulley devices or variations thereof.

### BREIF DESCRIPTION OF THE FIGURES

FIG. 1 is a perspective view of a preferred device of the present invention;

FIG. 2 is a plan view of the device of FIG. 1;

FIG. 3 is a front end view of the device of FIG. 1;

FIG. 4 is a side view of the device of FIG. 1;

FIG. 5 is a plan view if the device of FIG. 1 before it is mounted to a tree;

FIG. 6 is a schematic view of the device of FIG. 1 mounted to a tree; is a perspective view of a further preferred device of the present invention;

FIG. 7 is a perspective view of a further preferred device of the present invention;

FIG. 8 is a plan view of the device of FIG. 7;

FIG. 9 is a front end view of the device of FIG. 7;

FIG. 10 is a side view of the device of FIG. 9; and

FIG. 11 is a schematic view of a preferred device of a further broad form of the invention.

### DETAILED DESCRITPION OF THE FIGURES

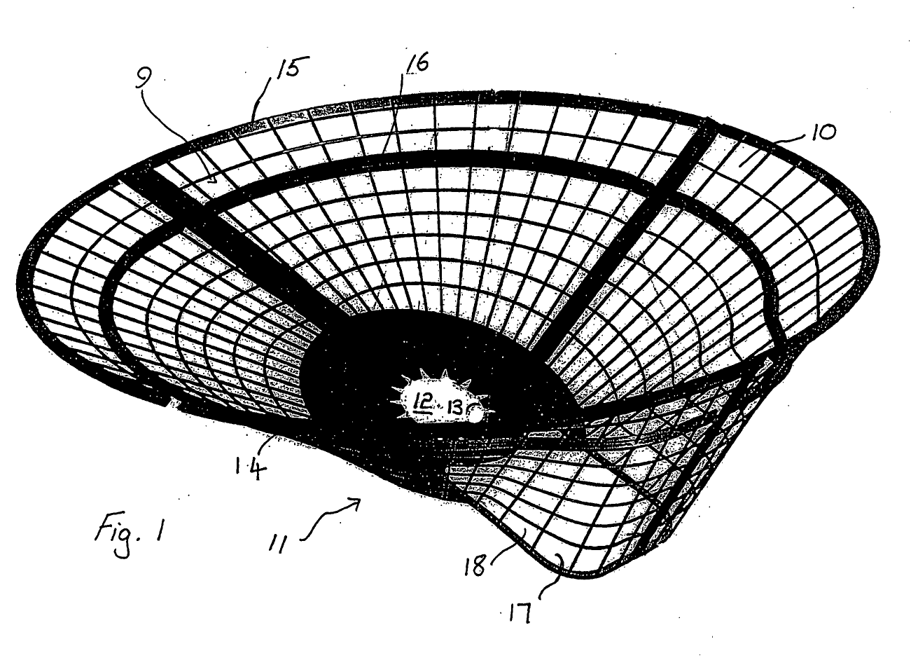

FIG. 1 shows a preferred device 11 of the present invention. The device 11 is in the form of a net constructed from a thermoplastics material such as polyethylene, polypropylene or mixtures and blends thereof. The plastics material is sufficiently flexible such that the device may be manually formed to shape when being mounted to a tree, as will be described further below. However, the device is also sufficiently rigid that when mounted to a tree, it can hold its shape.

The device 11 has a catching means in the form of a net portion 10. The device has an aperture 12 and a collar portion 14 surrounding the aperture 12. The net and collar form a continuous curved wall extending about the aperture. In use, a tree trunk passes through aperture 12. The outer circumference of this aperture 12 is lined with tree contacting fingers 13. These fingers 13 are at least partially flexible and can be pushed upwards or downwards by contact with a tree trunk. It can be seen therefore that the aperture 12 can be placed around trees having different diameters, the difference in diameter being accommodated by the movement of the fingers 13. The fingers 13 also enables the device to be mounted to tree trunks, which are not strictly circular in cross-section. About the aperture 12 is a solid collar 14. In use, this collar 14 can act as a barrier to animals climbing the tree trunk to eat the fruit. For example, it is known that rodents are able to climb coconut trees to access coconuts.

The upper perimeter 15 of the net portion 10 is provided with a ring of thicker plastic, which serves to reinforce the perimeter. A second reinforcing ring 16 is spaced from the outer ring 15. In use, the reinforcing rings assist 15, 16 in the device 11 retaining the shape as illustrated.

The area within the perimeter 15 defines a catching zone 9. Any fruit falling within this zone 9 will be caught by the device. FIGS. 2, 3 and 4 show plan, end and side views respectively of device 11. It can be seen in FIG. 2 that the catching zone is circular in plan view and is substantially in the shape of a scalene cone. The aperture 12 is centrally located within the circle when viewed in plan. The catching zone netting may vary depending on the selection of fruit bearing trees.

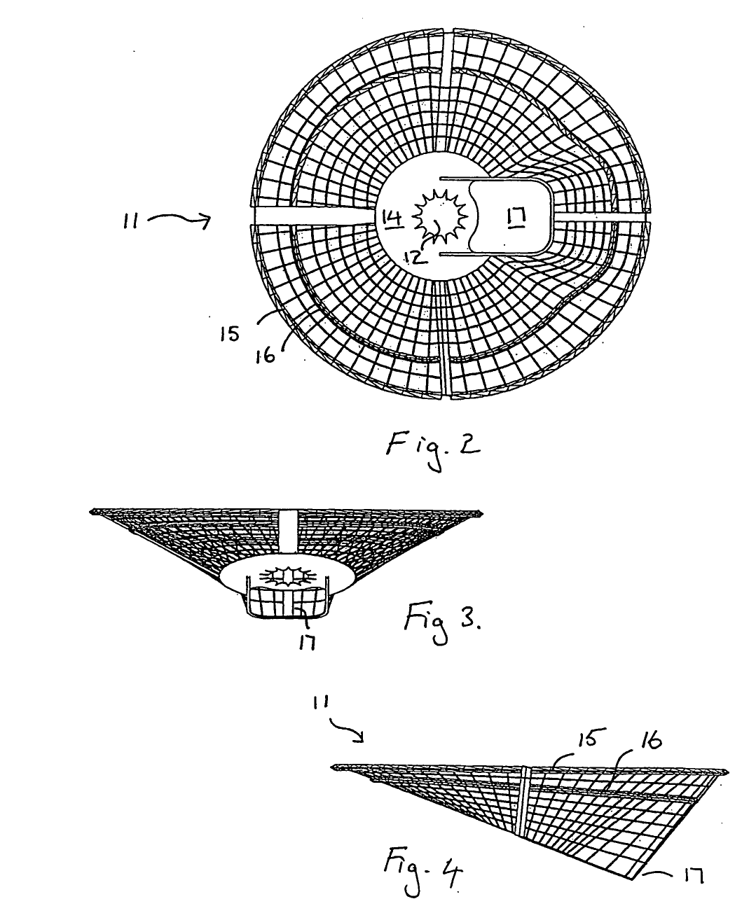

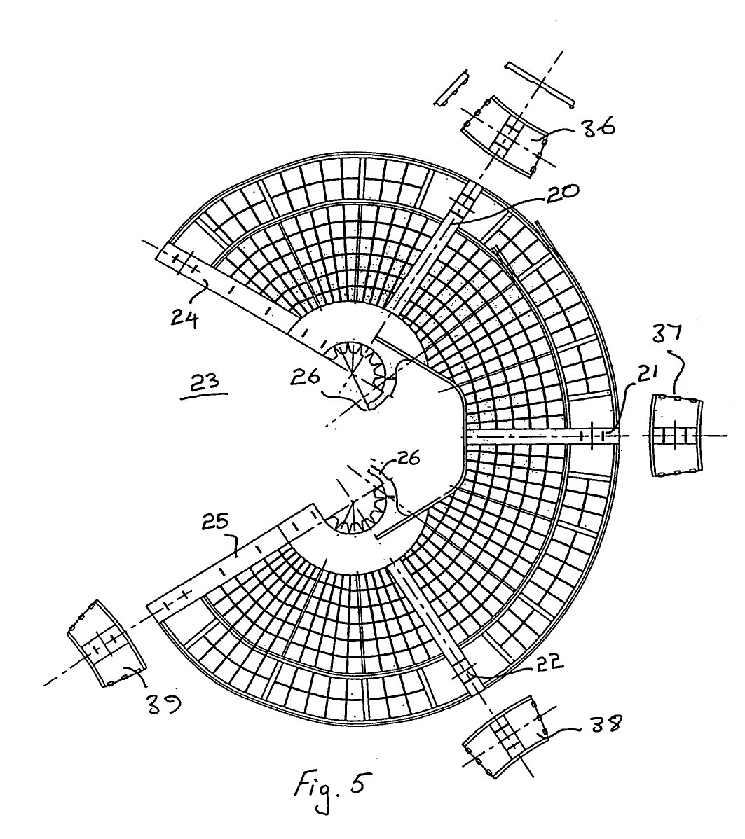

The device has a collecting zone, 17 which when the device is mounted to a tree, the collecting zone is located lowermost. This may be more clearly seen by reference to FIGS. 3 and 4. It can be seen that fruit falling within the catching zone is guided by the curvature of the net 10 towards the collecting zone 17. The collecting zone 17 has an aperture 18 through which collected fruit may pass. The collecting zone may be provided with a closure for the aperture 18 such that if desired fallen fruit may collect in the collecting zone and be removed as desired by an operator.

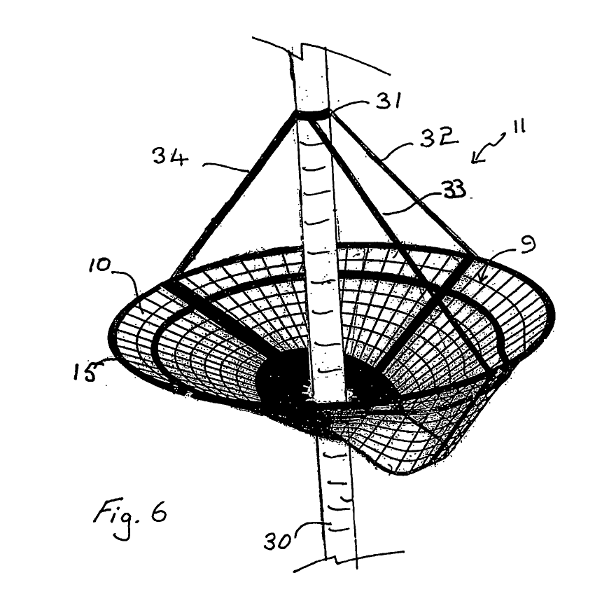

FIG. 5 shows the device 11 before being mounted to a tree. The device can essentially be laid out flat. In order to assist in transport and storage the device 11 is provided with fold lines 20, 21, 22 to allow the device to be folded and stored in a flat manner. In the unfolded and flat position, the device has an oval shape with a wedge 23 removed therefrom. Joining flaps 24, 25 extend along each side of the wedge 23. During mounting to a tree, the device 11 is placed about a tree trunk, flaps 24, 25 are brought together and joined. As the flaps 24, 25 are brought together the device takes a shape similar to that of a scalene cone as can been seen from FIG. 1. The device also includes inwardly facing tabs 26, which are also joined.

FIG. 6 shows schematically the device 11 of FIG. 1 mounted to a tree trunk 30. The device 11 includes a collar 31 mounted to the tree trunk above the net portion 10. Four flexible support members 32, 33, 34, (the fourth not being visible) extend from the collar 31 and attach to the perimeter 15 of the net portion 10. Support members are typically manufactured from nylon webbing. The perimeter 15 is provided with reinforced eyelets 36, 37, 38, 39, which may be seen in detail in FIG. 5. The support members are of adjustable length, which allows the angle of the device 11 to be varied with respect to the tree trunk. Such variation may be desired when the device 11 is to be mounted to a tree trunk, which is not vertical. The variation allows the upper perimeter 15 of the device 11 which defines the outer limit of the catching area to remain substantially parallel to the ground regardless of the angle of the tree trunk.

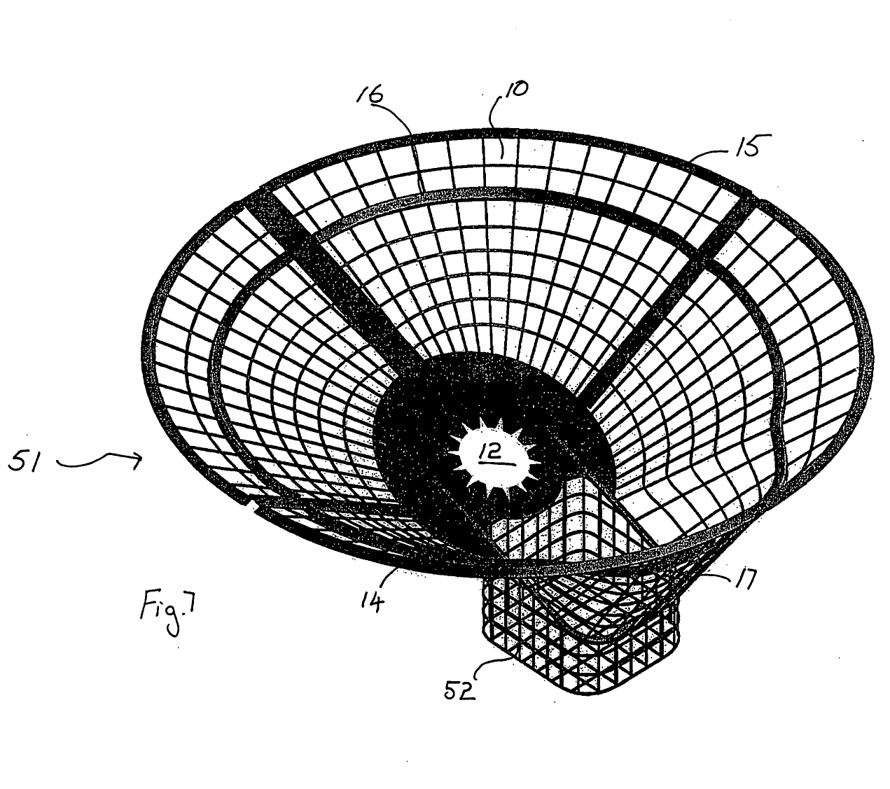

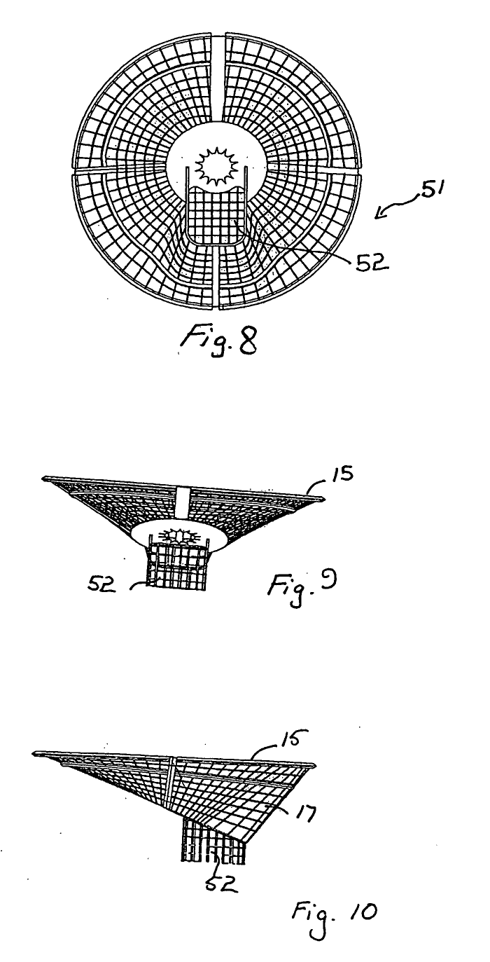

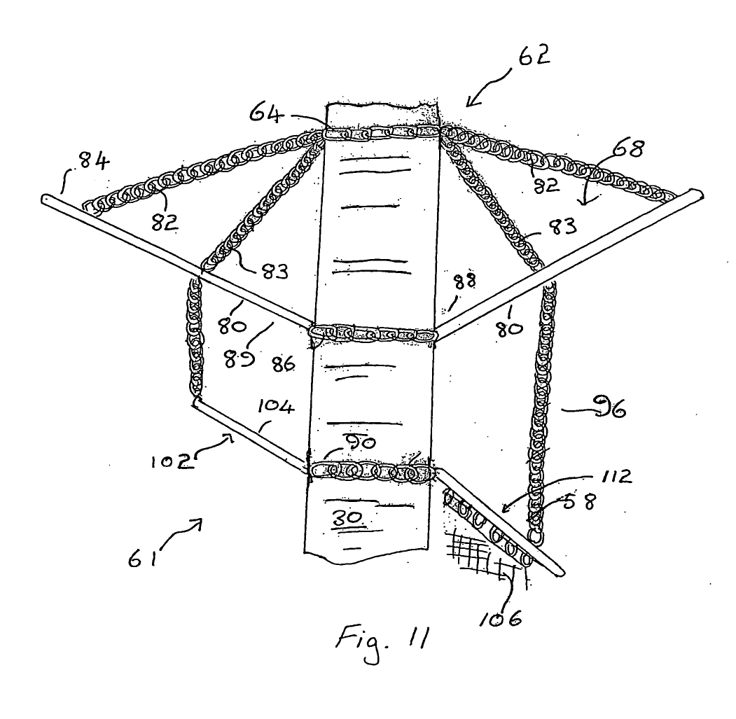

FIGS. 7 to 10 illustrate further preferred device of the present invention. This device 51 is similar to that of FIG. 1 and the same reference numerals will be used to describe the same or similar features. Device 51 includes a collecting basket 52 located below collecting zone 17. In use the basket 52 collects the fallen fruit. The basket is formed separately from the catching portion 54 of the net and can be removed to allow emptying of fruit therefrom.

This device is mounted to a tree in a similar manner to that shown in FIG. 6.

The basket is attached directly to the collar 31 from which the device is suspended. In this way, the weight of fruit in the basket is borne by the collar and does not deform the net.

In a particularly preferred form of the invention, the basket is attached to the collar by a pulley system, which can be operated by a user on the ground. An operator can activate the pulley so as to lower the basket to remove fruit therefrom and return the basket to its collecting portion without the need to climb the tree.

FIG. 11 shows a further device 61 of another form of the invention when mounted to a tree trunk 30. The device 61 includes a support means or structure 62. The support structure 62 includes an anchor means in the form of a collar-like member or collar 64, which is configured to encircle the trunk 30 of a coconut-bearing palm tree. The collar 44 is in the form of a length of chain, which is adjustable to fit a range of trunks having different diameters.

The device 61 also includes a catching means in the form of a catching arrangement 68, which is connected to the collar 64. The catching arrangement 68 includes a number of elongate elements or bars 80, which are arranged radially with respect to the collar 64. Each bar 80 is connected to the collar 64 with a tie 82. One end of each tie 82 is connected to a respective outer or distal end 84 of each bar 80. An opposed end of each tie 22 is connected to the first collar 14. A further tie 83 is connected between collar 64 and each bar 80; at a position intermediate the distal end 84 and an inner or proximal end 88 of each bar 80. The ties 82, 83 are in the form of lengths of chain. It will be appreciated that the ties may also be formed from lengths of webbing or other suitable material.

The device 61 also includes a second collar-like member or collar 86. The proximal end 88 of each bar 80 is connected to the second collar 86. The bars 20 and the ties 22 are configured so that the bars 20 extend outwardly and upwardly, in use, from the second collar 86, to define a catching zone. The ties 82, 83 are adjustable in length so that a size of the catching zone can be adjusted.

It will be appreciated that, in use, a space between consecutive bars 80 increases towards the distal ends 84. Thus, an obstruction means in the form of a plurality of further elongate elements, rods or netting is suitably positioned so that a failing coconut can land in the catching zone and roll towards trunk 30. The obstruction means are positioned such that a coconut can pass between a position space 89 proximate the trunk 30.

The device 61 includes a guide means 96 for guiding coconuts, which pass through the bars 20 into a collection zone 38. The guide means 96 includes a third collar-like member or collar 90. The third collar 100 is in the form of a length of chain.

The guide means 96 also includes a guide structure 102. The guide structure 102 is connected to the third collar 100. The guide structure 102 includes a guide means 104 which may be in the form of a plurality of rods or a net which is connected to and extend radially from the third collar 100.

Coconuts that land on the guide structure 102 are directed to a lowest region 112 in the guide structure 102.

The device includes a collection zone defined by a sock-like net 106 having a mouth 58 which is attached to the guide structure 102 with the opening in communication with the mouth 58. It follows that coconuts which fall onto the guide structure 102 are directed into the net 106.

It can be seen that the device of the present invention can act as a safety net to catch coconut and other heavy fruits before they hit the ground. The device can be mounted to tree trunks of varying diameter and can also be used effectively on tree trunks that are not strictly vertical. This is a limitation which the present inventor has identified with many prior art fruit collecting devices. The catching means of the device has no moving parts, which require maintenance or which can be damaged by falling fruit. The catching means of the device of the present invention may be manufactured in one piece and stored and transported in an essentially flat position. The device may be installed quickly and efficiently. The device is manufactured from a durable material which may be exposed to extended periods of inclement weather. In high wind situations it will be appreciated that the net provides minimal resistance as compared to prior art solid catching aprons and the like. The net also minimizes or avoids moisture build up within the device after periods of rain. In some prior art devices, water can be retained within the catching means and/or absorbed into the fabric of the catching material. This can lead to mould growth and degradation of the catching material.

It will be appreciated that minor modifications may be made to the invention as described and claimed herein without departing from the spirit and scope thereof.

1. A device for use with a fruit bearing tree, the device including;
a catching means mountable about a trunk of the tree beneath a fruit bearing region of the tree, a support means which includes an anchor means attachable about a tree trunk and at least two support members, and when the device is mounted about the trunk;
the catching means has at least one side wall;
the at least one wall defines a catching zone having a lowermost region to one side of the trunk;
the anchor means is attached to the trunk at a location above the catching zone and the at least two support members extend between the anchor means and the catching means; and
a collecting zone is located within the catching zone at or near the lowermost region of the catching zone such that fruit falling into the catching zone is guided by the wall towards the collecting zone.

2. The device of claim 1, wherein the catching zone has a shape selected from the group consisting of an inverted scalene cone and an inverted scalene pyramid.

3. The device of claim 2, wherein the collecting zone is located at or near the apex of the cone or pyramid.

4. The device of claim 3, wherein the catching zone has an upper perimeter defined by a base section of the cone or pyramid and in use a tree trunk passes through a centre portion of the upper perimeter.

5. The device of claim 1, wherein the catching means includes an aperture through which a tree trunk may pass, the aperture having a perimeter that can contact the trunk.

6. The device of claim 5, which includes a plurality of trunk gripping fingers extending into the aperture.

7. The device of claim 5, including a collar surrounding the aperture and the collar presents a barrier to an animal climbing the tree trunk towards the fruit bearing region.

8. The device of claim 1, wherein the anchor means is a collar of adjustable length.

9. The device of claim 1, wherein the support members are substantially flexible and are of adjustable length.

10. The device of claim 1, which includes a fruit collection means in communication with the collecting zone.

11. The device of claim 10, wherein the collection means is supported by the anchor means.

12. The device of claim 11, which includes means for lowering and raising the collection means such that a person on the ground can lower the collection means to enable emptying of fruit therefrom.

13. The device of claim 1, which is moveable from a flat storage position to an in use position.

14. A device for use with a fruit bearing tree, the device including a catching means mountable about the tree trunk beneath a fruit bearing region of the tree, an anchor means configured to be positioned at a desired height on the trunk of the tree above the catching means and support members extending between the catching means and the anchor means.

15. The device of claim 14, wherein the support members are of variable length.
